(19) United States
(12) Patent Application Publication
(10) Pub. No.: US 2020/0118111 A1
(43) Pub. Date: Apr. 16, 2020

(54) DISPLAYING ELECTRONIC CHANGE OBJECTS

(71) Applicant: Tope Folayan, Modesto, CA (US)

(72) Inventor: Tope Folayan, Modesto, CA (US)

(21) Appl. No.: 16/599,008

(22) Filed: Oct. 10, 2019

Related U.S. Application Data
(60) Provisional application No. 62/743,649, filed on Oct. 10, 2018.

(51) Int. Cl. G06Q 20/32; G06Q 20/20; G06Q 20/36

(52) U.S. Cl. CPC G06Q 20/3276; G06Q 20/204; G06Q 20/3272; G06Q 20/36; G06Q 20/3255

(57) ABSTRACT

A graphical user interface (GUI) displays an electronic change object and a non-electronic change object. The electronic change object is to display a first area and a second area in the GUI. The first area is to display electronic change format objects and the second area is to render an electronic change representation of a selected electronic change format for display. The electronic change representation may be read via a reader or transmitted via a communications device to transfer electronic from a first account to a second account associated with a user.

### BACKGROUND

Some payment methods to consummate transactions do not require a return of change to a purchasing consumer. As an example, when credit cards are used to pay for goods or services, an exact amount for the goods and services is tendered to the merchant/seller. The credit card company tenders this exact amount on behalf of the purchaser; at a future date, the purchaser can repay the amount (loan) in accordance with the agreed upon terms of the credit card. Another payment method that does not require a return of change is payment via checks, bank transfers, wires, etc. The exact amount for the purchased goods and services is simply presented or transferred to the merchant.

### BRIEF DESCRIPTION OF THE DRAWINGS

FIG. 1 is a flow chart illustrating an example implementation of electronic change objects display and transmittal of electronic change.

FIG. 2 is an example implementation of a display for electronic change objects.

FIG. 3 is an example implementation of a subsequent display for electronic change objects of FIG. 2.

FIG. 4 is an example implementation of a subsequent display for electronic change objects of FIG. 2.

FIG. 5 is a block diagram illustrating an example implementation of an electronic change objects display and the transmission of electronic change.

### DETAILED DESCRIPTION

As discussed above, some payment methods (e.g., credit cards, checks) wires that are used to consummate transactions do not require a return of change to a purchasing consumer. However, one payment method that may require a return of change is cash. A purchaser need not provide an exact amount to the seller; and in fact, oftentimes exact amounts are not presented. The purchaser may tender physical cash over and above the cost of the goods or services. In turn, the merchant then provides the buyer with an amount of change that is the difference between the amount tendered and the cost of goods or services. Many purchasers find the receipt of physical change to be highly inconvenient, oftentimes, the change might be coins that are not easily stored in the purchaser's pockets, wallet, etc. Even when change can be stored, purchasers must carry large amounts of currency to make any meaningful purchase because of the diminutive value of change. For the same reason, change is often discarded, misplaced, and not cared for by many users.

In one example of the present disclosure, a graphical user interface (GUI) displays a first or electronic change object and a second or non-electronic change object. The electronic change object is to display a first area and a second area in the GUI. The first area is to display electronic change format objects and the second area is to render an electronic change representation of a selected electronic change format for display. In one example, the electronic change format object may be a QR code object. In another example, the electronic change format object may be a USSD (Unstructured Supplementary Service Data) object.

The representation of the electronic change format objects may be scanned via a reader to transfer electronic change from a first account to a second account associated with a user. In another implementation, the electronic change representation may be hot keyed into display and selection of the electronic representation initiates electronic change transfer from the first account to the second account. In this manner, users need not be inconvenienced by the receipt of physical change, which are not easily stored on a user's person. Users need not carry large amounts of currency to make a purchase and can avoid the loss of physical change which is often discarded, misplaced, and not cared for by many users

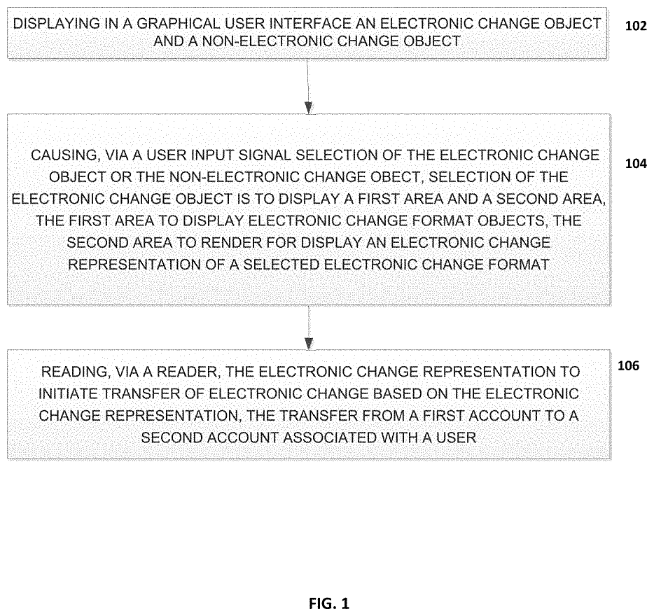

Although the description has been described with respect to particular implementations thereof, these particular implementations are merely illustrative, and not restrictive. FIG. 1 is a flow chart illustrating an example implementation of electronic change objects display and transmittal of electronic change. At block 102, an electronic change object and a non-electronic change object (which may be optional) are displayed in a GUI (graphical user interface). One or more objects may be displayed as electronic change objects that cause display of electronic change format objects for transmittal of associated electronic change. In another implementation, one or more objects may also be displayed as non-electronic change objects that are associated with non-electronic change currency (e.g. physical cash).

The one or more objects may be tools, widgets and/or any other element that the user can interact with on the GUI. A widget is an element that the user interacts with on the user interface and the element is adapted to facilitate manipulating, interacting with, and/or viewing a particular collection of or type of data. The widget may be thought of as a control for the user in the GUI and the widget may provide an interaction point for the manipulation of a collection of data or a particular kind of data. In an embodiment, the widget is a visual building block in the GUI that represents data processed by and/or stored for a software application and the available interactions on this data.

Referring to FIG. 1, at block 104, a user input signal or user interaction indication to select either an electronic change object or non-electronic change object may be received from a user. Selection of the electronic change object is to display on the GUI a first area and a second area as will be discussed below.

The first area may display electronic change format objects. An electronic change format object may be a data-representation element that might be machine-readable, multi-dimensional such as a QR code, bar code, etc. The data contained therein may include an amount of the electronic change, buyer and buyer account information, location of purchase, and time stamp information.

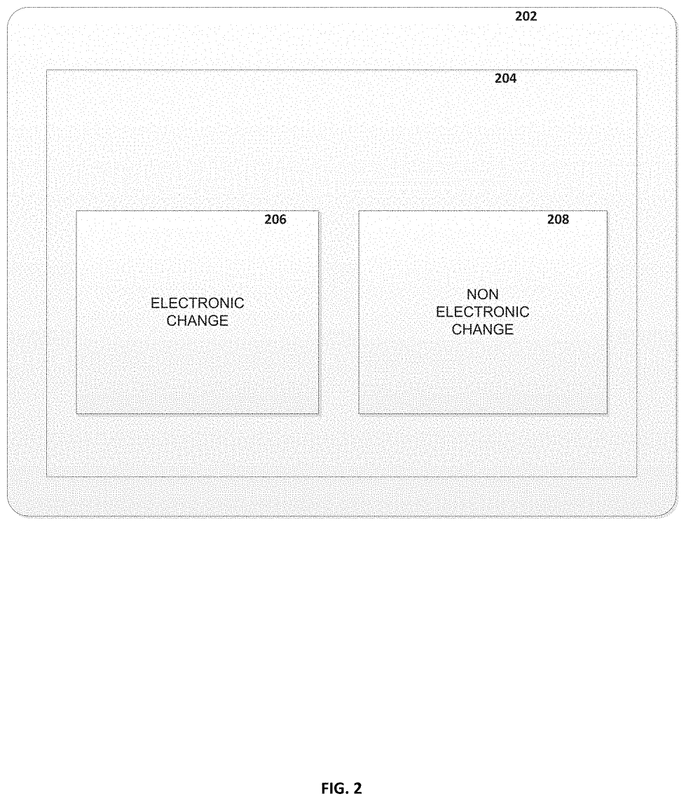

The second area of the GUI is to render an electronic change representation of a selected electronic change format. In one example, the electronic change representation may be rendered and scanned by an electronic reader associated with a user's mobile device. FIG. 2 illustrates an example display of data objects on a GUI. Specifically, a GUI 202 includes a display area 204 where visual images, text and palettes are displayed. Within display area 204, one or more widgets such as icons may be displayed. An icon is an element on the GUI that represents a file, a program, a command, a collection of data, a document, one or more database table(s), or any combination thereof.

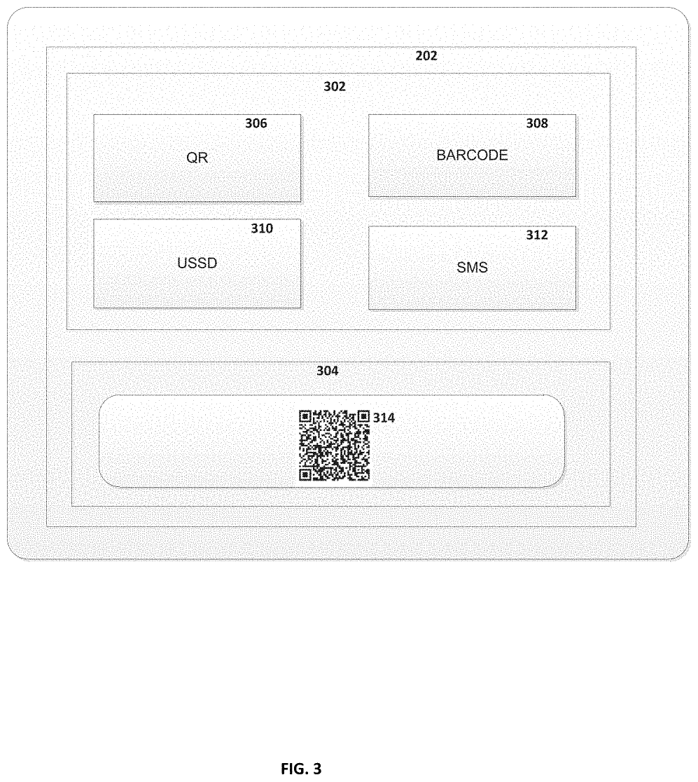

Here, specifically, electronic change object 206 and non-electronic change object 208 are displayed. When a user input signal (or another selection indication) is received to select electronic change object 206, GUI 202 transitions into a first area 302 and a second area 304 of FIG. 3. In FIG. 3, although first area 302 is shown above second area 304, one skilled in the art will understand both areas can be in different orientations relative to each other. First area 302 is to display multiple electronic change format objects while second or format display area 304 is to render an electronic change representation of a selected electronic change format for display in format display area 304 of GUI 202.

The electronic change format objects are data elements encoded with electronic change information. In one example, the electronic change information may include an amount of the electronic change, consumer/purchaser information including name and account number, merchant information, location of purchase, and time stamp information, all of which may be encrypted.

In FIG. 3, electronic change format objects may include a QR (Quick Response) object 306, barcode object 308, USSD object 310 and SMS object 312. Although not shown, other electronic data objects may be applicable such as MMS (Multimedia

Messaging Service), or sonic data transfer, etc. Upon selection of QR object 306, a QR code 314, which is an electronic change representation for the selected QR object 306, is generated. QR code 314 may utilize four standardized encoding modes (alphanumeric, numeric, kanji, byte/binary) to store data efficiently. QR code 314 might be a machine-readable optical label that contains electronic change information.

QR code 314 may also contain data for a locator, tracker or identifier that points to an application or website to facilitate transmittal of electronic change from one account to another. In one example, QR code 314 might include black squares arranged in a square grid on a white background, which is scannable by an imaging device (e.g. a mobile device camera), and processed using error correction until the image can be appropriately interpreted. The required data can then be obtained from patterns that are present in vertical and horizontal components of the image.

Once generated, QR code 314 is rendered for display within format display area 304. Thus, in one implementation, format display area 304 is to render electronic change representation of objects selected from first area 302. Similarly, when barcode object 308 is selected, a representative image representation such as a barcode (not shown) is displayed in format display area 304. The displayed barcode is a visual, machine-readable form representation of electronic change. The barcode may be a one-dimensional representation of varying widths and spacings of parallel lines.

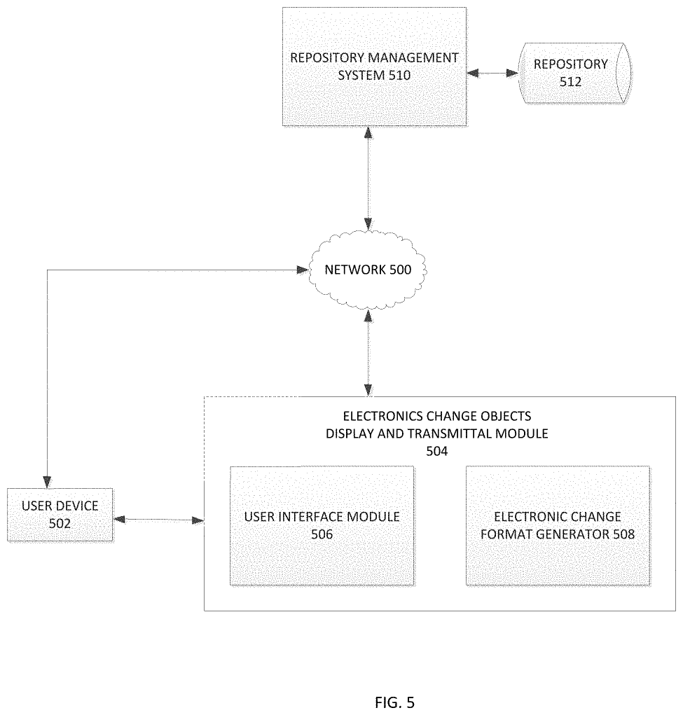

When USSD object 310 is selected, one or more USSD (Unstructured Supplementary Service Data) strings (not shown) are generated for display in format display area 304. In one implementation, format display area 304 is a selectable interface such as a touch screen, for example. Thus, the generated USSD string may be hot keyed into image format display area 304. This hot key avoids a user having to re-enter the generated USSD string (and other data associated with the electronic change). Unstructured Supplementary Service Data is a protocol used by GSM cellphones to communicate with service provider computers. The generated USSD string may be used by a mobile device (e.g. user device 502 of FIG. 5) to initiate electronic change transfer by sending the USSD string to the appropriate mobile device service provider to transfer electronic change from one account to another.

In FIG. 3, if SMS object 312 is selected, an SMS text/string is displayed by format display area 304. In one example, the SMS text/string may contain up to 160 characters, depending on the type of characters. In another example, the SMS text/string is via Application-to-Person, or A2P messaging to a messaging application. The SMS text/string may also be hot keyed into format display area 304.

Referring now to the flowchart of FIG. 1, at block 106, in one example, a reader, scanner, mobile device camera and the like is used to read the electronic change representation to initiate transfer of electronic change based on the electronic change representation, the transfer being from a first account to a second account associated with a user. In another example, as noted above, transfer may be initiated via a hot keying into format display area 304.

Specifically, a user's reader scans the electronic change representation that is displayed by format display area 304 to either store or initiate electronic change transfer. As an example, in one example implementation, a user (e.g. a product purchaser) may use a mobile device to scan the QR code 314. In turn, in one implementation, an associated application decrypts the information from the QR code (or barcode) and automatically initiates and transfers the electronic change amount from a first wallet or account (e.g. a merchant account) to a second wallet or account (e.g. buyer account).

In another example implementation, where the interface resides on a platform external to a mobile device, a user may use the mobile device to capture the USSD string displayed in format display area 304. This USSD string may then be hot keyed to automatically initiate and transfer the electronic change amount from the first wallet or account to a second wallet. The USSD string will include appropriate codes, the electronic change amount, the provider account, the account to which the amount is to be deposited. One skilled in the art will understand that a similar process can be used for other object modes including SMS, MMS and sound-based transactions.

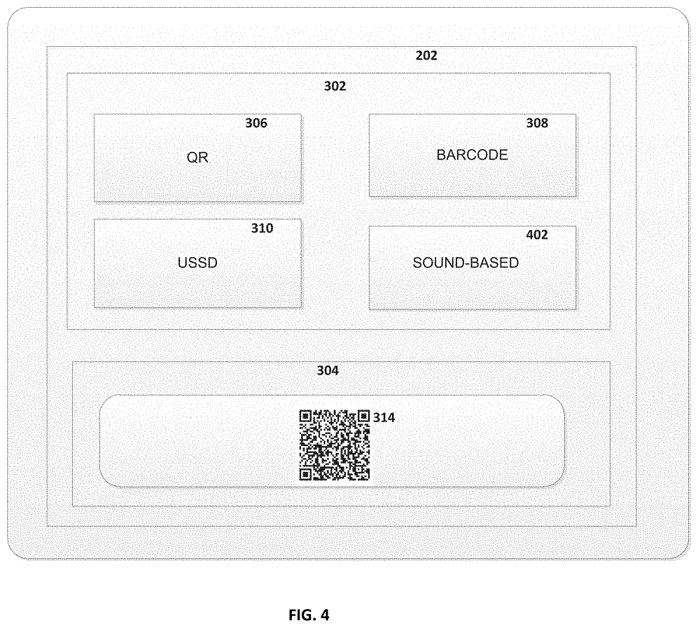

In this manner, users need not be inconvenienced by the receipt of physical change, which are not easily stored on a user's person. Users need not carry large amounts of currency to make a purchase and can avoid the loss of physical change which is often discarded, misplaced, and not cared for by many users. FIG. 4 is an example implementation of a subsequent display for electronic change objects of FIG. 2. Here, GUI 202 includes a sound-based object 402 that can function as described with reference to USSD string/text discussed above.

Although not shown, electronic change may be stored in an electronic change wallet on the mobile number of the user. Since it is uniquely identifiable, the mobile number may be an identifier for storing, in an encrypted state, the electronic change amount/value on the mobile device. Each subsequent transaction may increase or decrease the value of the electronic change. The value of the stored electronic change amount may be visually displayed in image display area 304. The electronic change wallet may be tracked and validated by repository management system 510 (of FIG. 5).

FIG. 5 illustrates a block diagram for an implementation of an electronic change objects display and transmit system. The infrastructure of network 500 is to send and receive both signals and messages according to one or more designated formats, standards, or protocols. Network 500 may be a collection of computer systems and/or devices that are interconnected by communications channels that facilitate communications and allows for sharing of resources and information among interconnected devices. Network 500 may provide for both wired and wireless communication between the various elements of FIG. 5. Examples may utilize network 500 for communication between elements of an implementation of the electronic change objects display as shown, including, but not limited to, the following: a user device 502, an electronic change objects display and transmittal module 504, a user interface module 506, an electronic change format generator 508, a repository management system 510 and a repository 512.

Repository Management System 510 is software that controls the creation, maintenance, and use of a Repository 512. Repository 512 may be any collection of data, such as a relational database, an object-oriented database, a cache, and/or a file system. In an example, the repository management system 510 may be a database server. Repository 512 may store the data for the electronics change objects display and transmittal module 504. This data may be used as a framework for electronics change objects software with additional data input to repository 512 to execute the software and/or the data stored for the framework may be a sufficient data to execute the electronics change objects software. Repository 512 may store electronic change information including user profiles (e.g. merchants, purchasers, mobile provider profiles), account information including account balances, account limits, transaction limits, etc.).

Electronics change objects display and transmittal module 504 may interface with a change indication system (not shown). An example of such a change indication system may be a point of sale system. However, the change indication system may be any system that can indicate an amount of change that is due to a user as a result of a transaction.

In FIG. 5, the electronics change objects display and transmittal module 504 includes user interface module 506 to generate, in one example, first area 302, format display area 304 (FIG. 3) and display area 204 (FIG. 2). Specifically, user interface module 506 may be used to create the widgets on the user interface, including but not limited to the windows, prompts, icons, objects, canvas window, palette window, and any other element used for the user interface. User interface module 506 may also assign and/or track assignment of attributes to the objects.

In one example use, display area 204 may be displayed to a first user to receive electronic change from a second user. A prior interface (not shown) might require the second user to enter an amount (and other relevant data) to be transferred the first user. In another example, the display area 204 may be displayed when a user is a purchaser. In this example, the purchase transaction may itself occur on a separate point of sale that interfaces with electronics change objects display and transmittal module 504.

In one process flow implementation, after display area 204 is displayed and the user does not desire physical change (currency), non-electronic change object 208 of display area 204 may be selected, at which point the user can collect physical change as desired. If electronic change is desired, the user may select electronic change object 206 of display 204. Responsive thereof, electronics change objects display and transmittal module 504 then generates first area 302 (of FIG. 3) and format display area 304 (of FIG. 3) is shown once an electronic change format representation is selected.

In the example of FIG. 3, the user may select any one of QR object 306, barcode object 308, USSD object 310 and SMS object 312. Here, if QR object 306 is selected for example, electronic change format generator 508 generates the QR code 314 for scanning by user device 502. In one implementation, electronic change format generator 508 communicates with repository management system 510 to validate the merchant ID, user ID, amount availability, etc.

Upon successful validation, electronic change format generator 508 then generates QR code 314. QR code 314 includes encrypted information indicating an amount of the electronic change, buyer and buyer account information, location of purchase, and time stamp information. Note that if USSD object 310 or SMS object 312 is selected, a USSD string or SMS text is generated and displayed in format display area 304; the user may then capture this for transmittal from user device 502 to a predetermined phone number. This process can be hot keyed into a selectable format display area 304.

The predetermined phone number may be associated with repository management system 510, which initiates transfer of electronic change from one user to another. As noted, user accounts may be stored in repository 512 and managed by repository management system 510, which effectuates the transmittal of electronic change between accounts.

Alternatively, the SMS text/string can be manually entered by the user for transmission to the predetermined phone number. In one implementation, for all electronic format options, electronic change may be transmitted between accounts if encryption keys, time stamp and location match. Here, encryption may be used to match user keys to ensure that transaction time and the physical locations of a transaction match. Transaction times coordination (in one example) may be from the system clocks.

The electronic change objects display and transmittal module 504 may be integrated with or interfaced with a point of sale system and the like. User interfaces may be displayed on a graphical user interface associated with a standalone computer, with a processor specially programmed by software examples described herein. User interfaces may be on user device 502 which may be a mobile device or one or more computer systems or devices.

In summary, a non-transitory computer-readable storage medium may be provided to store instructions, which when executed by one or more processor, causes the one or more processors to perform operations comprising: displaying, in a graphical user interface, a first or electronic change object and a second or non-electronic change object; causing, via a user input signal selection of one of either the first or the second electronic change object, wherein selection of the electronic change object is to display a first area and a second area in said graphical user interface, wherein the first area is to display a plurality of electronic change format objects and wherein the second area is to render an electronic change representation of a selected electronic change format for display in the second area of the graphical user interface; and reading, via a reader, the electronic change representation to initiate transfer of electronic change based on said electronic change representation, the transfer being from a first account to a second account associated with a user.

The non-transitory computer-readable storage medium may also cause displaying, in a graphical user interface, an electronic change object; causing, via a user input signal selection of the electronic change object, wherein selection of the electronic change object is to display a first area and a second area in said graphical user interface, wherein the first area is to display a plurality of electronic change format objects and wherein the second area is both to display an electronic change representation of a selected electronic change format; and to allow selection of the second area that is hot keyed.

Any suitable programming language can be used to implement the routines of particular embodiments including C, C++, Java, assembly language, etc. Different programming techniques can be employed such as procedural or object oriented. The routines can execute on a single processing device or multiple processors.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit. “in” and “on” unless the context clearly dictates otherwise.

I claim:

1. A non-transitory computer-readable storage medium storing instructions, which when executed by one or more processor, causes the one or more processors to perform operations comprising:
displaying, in a graphical user interface, an electronic change object and a non-electronic change object;
causing, via a user input signal selection of one of either the electronic change object or the non-electronic change object, wherein selection of the electronic change object is to display a first area and a second area in said graphical user interface, wherein the first area is to display a plurality of electronic change format objects and wherein the second area is to display an electronic change representation of a selected electronic change format object; and
reading, via a reader, the electronic change representation to initiate transfer of electronic change based on said electronic change representation, the transfer being from a first account to a second account associated with a user.

2. The computer-readable storage medium of claim 1 wherein the plurality of electronic change format objects is a QR code object, barcode object, an SMS (Short Message Service), and USSD (Unstructured Supplementary Service Data) object.

3. The computer-readable storage medium of claim 1 wherein the plurality of electronic change format objects is any one of a QR code object, barcode object, an SMS (Short Message Service), sound based, and USSD (Unstructured Supplementary Service Data) object.

4. The computer-readable storage medium of claim 1 further comprising causing display of an electronic change wallet object to store electronic change on a mobile device.

5. The computer-readable storage medium of claim 4 wherein the first account is associated with the mobile device of an item purchaser.

6. A non-transitory computer-readable storage medium storing instructions, which when executed by one or more processor, causes the one or more processors to perform operations comprising:
displaying, in a graphical user interface, an electronic change object;
causing, via a user input signal selection of the electronic change object, a display of a first area and a second area in said graphical user interface, wherein the first area is to display a plurality of electronic change format objects and wherein the second area is both to display an electronic change representation of a selected electronic change format; and to allow selection of the second area when hot keyed.

7. The non-transitory computer readable medium of claim 6 further comprising employing a mobile device number of a mobile device as an identifier to store the electronic change.

8. The non-transitory computer readable medium of claim 6 further comprising:
reading, via a reader, the electronic change representation to initiate transfer of electronic change based on said electronic change representation, the transfer being from a first account to a second account associated with a user.

9. The computer-readable storage medium of claim 6 wherein the plurality of electronic change format objects is a QR code object, barcode object, an SMS (Short Message Service) and USSD (Unstructured Supplementary Service Data) object.

10. A graphical user interface comprising:
first area and a second area, wherein the first area is to display a plurality of electronic change format objects and wherein the second area is both to display an electronic change representation of a selected electronic change format; and to allow selection of the second area when hot keyed.

11. The graphical user interface of claim 10 wherein the plurality of electronic change format objects is a QR code object, barcode object, an SMS (Short Message Service) and USSD (Unstructured Supplementary Service Data) object.
